(19) United States
(12) Patent Application Publication
(10) Pub. No.: US 2006/0092992 A1
(43) Pub. Date: May 4, 2006

(54) Monoblock Laser

(75) Inventor: John E. Nettleton, Fairfax Station, VA (US)

Correspondence Address: DEPARTMENT OF THE ARMY;CECOM LEGAL OFFICE, FORT BELVOIR, AMSEL-LG-BELV, 10235 BURBECK ROAD, FORT BELVOIR, VA, 22060-5806, US

(73) Assignee: UNITED STATES ARMY AS REPRESENTED BY THE DEPT OF THE ARMY

(21) Appl. No.: 10/974,830

(22) Filed: Oct. 28, 2004

(51) Int. Cl. H01S 3/11; H01S 3/10

(52) U.S. Cl. 372/10; 372/21

(57) ABSTRACT

An improved monoblock laser cavity is made by applying circular apodizing coatings to the various components of the monoblock laser. The apodization of the laser cavity faces improves the beam divergence of the laser and thus, increases brightness, by encouraging only the lower order modes to lase.

### GOVERNMENT INTEREST

The invention described herein may be manufactured, used, sold, imported, and/or licensed by or for the Government of the United States of America.

### FIELD OF THE INVENTION

The present invention generally relates to optically pumped, solid-state, Q-switched and linearly polarized laser cavity assemblies and, more specifically, to an improved monoblock laser and the method of making the laser.

### BACKGROUND OF THE INVENTION

The present invention is an improvement to the monoblock laser described and claimed in U.S. Pat. No. 6,556,614, entitled, Monolithic Solid State LASER Assembly and Method of Manufacture, issued Apr. 29, 2003. This patent is incorporated herein by reference with only the necessary parts being duplicated in this specification.

The invention described in U.S. Pat. No. 6,556,614, is a photon pumped laser cavity assembly consisting of a pair of coaxial rods made from laser gain material with precisely cut side-faces and end-faces. Some of the end-faces are covered by at least one of a dielectric or metal coating highly reflective to the laser output beam, a wafer of polarizing material, and a dielectric or metal coating partially reflective to the laser beam. More details of this prior art will be described in the Detailed Description of the Invention.

Laser range finders are becoming an increasingly vital component in high precision targeting engagements. The precise and accurate range to target information is an essential variable to the fire control equation of most weapon systems. Unfortunately, current fielded laser range finders are bulky, heavy and expensive. These laser range finders were not developed with the idea that would be carried by forces.

The monoblock laser described in the U.S. Pat. No. 6,556,614 makes the development/fabrication of a very low cost, compact laser range finder feasible. Unfortunately, the beam divergence of the monoblock laser is rather larger (>8 mRad)(low brightness laser) which means a sizable optic is required to collimate the monoblock laser output.

Accordingly, there is in a need in the prior to make monoblock lasers brighter by decreasing the beam divergence of the laser. The present invention addresses this need.

### SUMMARY OF THE INVENTION

One object of the present invention is to make monoblock lasers brighter by decreasing the beam divergence of the laser. This is achieved by applying circular apodizing coatings to the various components of the monoblock laser. The apodization of the laser cavity faces improves the beam divergence of the laser and thus, increases brightness, by encouraging only the lower order modes to lase.

### BRIEF DESCRIPTION OF THE DRAWINGS

The foregoing and other objects, aspects and advantages will be better understood from the following detailed description of the invention with reference to the drawings, in which:

FIG. 1 shows a monoblock laser according to the prior art. FIG. 1a shows a cross section of a monoblock laser.

FIG. 2 shows a cross-section of the monoblock laser according to the present invention.

### DETAILED DESCRIPTION OF THE INVENTION

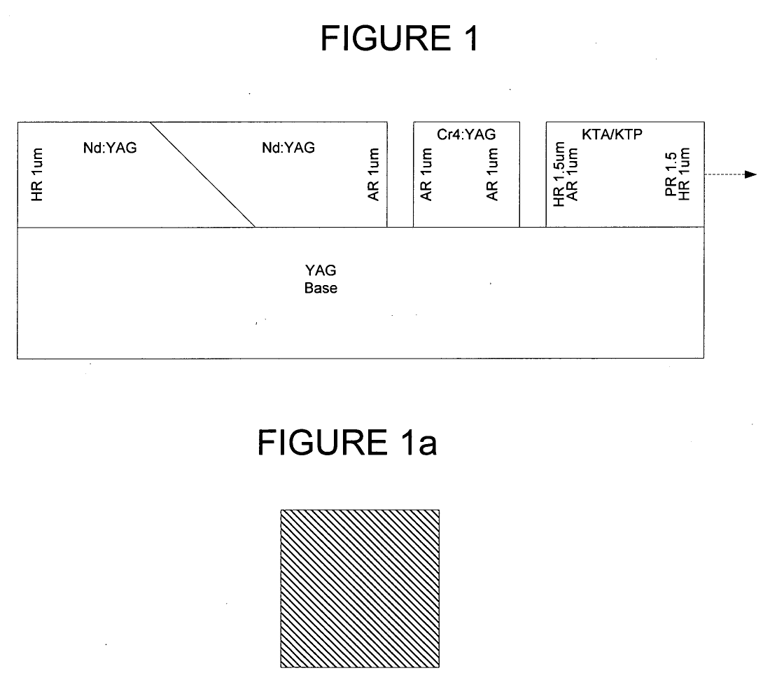

As shown in FIG. 1, the prior art monoblock laser compromises a block of laser gain material such as Neodymium:Yttrium-Aluminum-Garnet (Nd:YAG) and a high reflector having a wavelength about 1 um disposed on one side and an antireflector having a wavelength of 1 um disposed on an opposite end. Optically coupled to the laser gain material is a Q-switch made of a material such as Cr4+:YAG. The Q-switch is coupled to the laser gain material with an antireflector coating matching (1 um) the antireflector coated on the laser gain material. The Q-switch at the opposite end has another an antireflector coating of 1 um disposed at an output end of the Q-switch. Then, the Q-switch is optically coupled to the OPO cavity which has, in order, a high reflector coating of 1.5 um, an antireflector coating of 1 um on an input end and then, at the output end, a partial reflector coating of 1.5 and a high reflector coating of 1 um. The OPO cavity may be made of such materials as KTiOPO₄ (KTP)/KTiOAsO₄ (KTA).

As shown in FIG. 1a, the typical cross-section of a monoblock laser is square or rectangular, even though it can take various other forms.

The improvement of the present invention is made by applying circular apodizing coatings between the various elements of the monoblock laser, i.e. the laser gain material and the Q-switch, and the Q-switch and the OPO cavity. For example, this can be accomplished by applying any coating in a circular cross-section that would encourage only the lower order modes to lase and smooth out laser pulse around its edges. Given this disclosure, those skilled in the art would be recognize that this can be accomplished by any number of apodizing filter coatings known in the art.

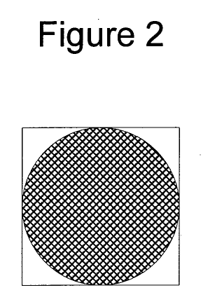

As shown in FIG. 2, the apodizing coatings are applied in a circular fashion.

As those skilled in the art will recognize, the circular apodizing coating will decrease the beam divergence and thus improves the brightness of the monoblock laser. The tighter beam divergence (improved brightness) of the improved monoblock laser allows for the use of a smaller diameter optic to collimate the laser output for use in a laser range finder.

This improved monoblock laser cavity is still a simple module that requires none of the labor extensive alignment procedures as current laser range finder solid-state sources. No optical holders have to be fabricated, no complex engineering is required to design the optical cavity, and no precise laser cavity alignment(s) are required. Therefore, production labor and material costs are greatly reduced.

Moreover, the improved monoblock laser cavity of the present invention is a modular component. The modularity lends to ease of design for different pump sources. It can be incorporated in a flash lamp pumped or laser diode pumped system.

The present invention may be used as the laser source in very compact laser range finders that require more than 2 kilometers range performance. It generates eye safe laser output for eye safe laser range-finding. These laser range finders have both military and commercial applications. The compact design of the improved monoblock laser cavity also lends itself to placement in other laser based portable/handheld devices. These may be medical devices, industrial tools or scientific equipment that would benefit from the size/weight reduction, dependable performance, and low cost.

While this invention has been described in terms of preferred embodiment consisting of a one piece assembly made a number of critically arranged elements, those skilled in the art will recognize the true scope of the invention as defined in the claims that follow.

1. An improved monoblock laser cavity comprising:
a laser source material;
a Q-switch;
an OPO crystal; and
coatings that applied to ends of the laser source material, the Q-switch and the OPO crystal that encourage only lower order modes of an induced laser pulse to lase.

2. The improved monoblock laser cavity of claim 1 wherein coatings are apodizing.

3. The improved monoblock laser cavity of claim 2 wherein the coatings are circular.

4. A method of making an improved monoblock laser cavity comprising the steps of:
Providing for a laser source material;
Providing for a Q-switch;
Providing for an OPO crystal; and
Applying coatings to ends of the laser source material, the Q-switch and the OPO crystal that encourage only lower order modes of an induced laser pulse to lase.

5. The improved monoblock laser cavity of claim 4 wherein coatings are apodizing.

6. The improved monoblock laser cavity of claim 5 wherein the coatings are circular.
